(19) United States
(12) Patent Application Publication
(10) Pub. No.: US 2014/0149034 A1
(43) Pub. Date: May 29, 2014

(54) APPARATUS FOR INTEGRATING MULTIPLE RATE SYSTEMS AND METHOD OF OPERATING THE SAME

(71) Applicant: Electronics and Telecommunications Research Institute, Daejeon-city (KR)

(72) Inventors: Seong-Yun CHO, Daejeon (KR); Chang-Rak YOON, Daejeon (KR); Jae-Hong OH, Daejeon (KR); Hye-Sun PARK, Daejeon (KR); Kyong-Ho Kim, Daejeon (KR)

(21) Appl. No.: 13/943,535

(22) Filed: Jul. 16, 2013

(30) Foreign Application Priority Data
Nov. 26, 2012 (KR) 10-2012-0134253

(51) Int. Cl. G01C 21/16

(52) U.S. Cl. CPC G01C 21/165
USPC 701/472

(57) ABSTRACT

Disclosed herein are an apparatus for integrating multiple rate systems and a method of operating an apparatus for integrating multiple rate systems. In the method of operating the apparatus, navigation information is calculated through an inertial measurement unit, and mean values and variances of initial state variables of the navigation information are set. Sigma points are calculated using the mean values and the variances. The mean values are time-propagated until measurement information is input through a Global Positioning System (GPS). When the measurement information is input, the sigma points are time-propagated at intervals of a frequency of the measurement information. Variances are calculated using the time-propagated sigma points. The navigation information is updated using the time-propagated mean values, the calculated variances, and the measurement information.

### CROSS REFERENCE TO RELATED APPLICATION

This application claims the benefit of Korean Patent Application No. 10-2012-0134253 filed on Nov. 26, 2012, which is hereby incorporated by reference in its entirety into this application.

### BACKGROUND OF THE INVENTION

1. Technical Field

The present invention relates generally to an apparatus for integrating multiple rate systems and a method of operating the apparatus and, more particularly, to technology for utilizing an Unscented Kalman Filter (UKF) (also referred to as a ‘sigma point Kalman filter’) revised to reduce a computational load when an existing UKF that was used to integrate several systems is used to integrate systems having different update rates.

2. Description of the Related Art

Recently, when the integration of two or more systems is required, Kalman filters are most commonly used. In this case, when systems are non-linear systems, an Extended Kalman Filter (EKF) is most commonly used.

One disadvantage of an EKF is that the estimated error of the filter increases or occasionally diverges when an initially estimated error is large.

In order to solve the problem, a large error model is designed and used, or an unscented Kalman filter is used. Recently, such an unscented Kalman filter is most commonly used.

An unscented Kalman filter utilizes a scheme for setting a plurality of sigma points using the mean value and covariance of state variables of the filter, time-propagating the sigma points using a non-linear equation without change upon performing time propagation, and calculating the mean value and covariance of the state variables using resulting values, thus solving the problem of calculating an erroneous covariance using an approximated system determinant in an extended Kalman filter.

As a result, the unscented Kalman filter is advantageous in that, even if the initially estimated error is large, an error rapidly converges on a small value, unlike in the case of the extended Kalman filter.

However, the unscented Kalman filter is disadvantageous in that, when systems having multiple rates are integrated, a plurality of sigma points are time-propagated several times between measurement updates, thus greatly increasing a computational load compared to the extended Kalman filter.

For example, when an Inertial Measurement Unit (IMU) updated at a rate of 50 Hz and a Global Positioning System (GPS) updated at a rate of 1 Hz are integrated with each other, the extended Kalman filter updates a single mean value 50 times per state variable between measurement updates, whereas the unscented Kalman filter updates N sigma points 50 times between measurement updates.

In this case, when the number of state variables is L, N is set to 2 L+1 or L+2 according to the type of unscented Kalman filter.

Therefore, as the number of state variables is large, the performance of a microprocessor must be high so as to perform real-time driving; otherwise, the unscented Kalman filter is inevitably, limitedly used so as to perform real-time driving.

U.S. Patent Publication No. 2005-0251328 discloses technology for time-propagating all sigma points and calculating the mean value and covariance of each state variable. However, the technology disclosed in this patent is limited in that, when the number of state variables is large, a computational load increases, and then a high-performance microprocessor is required.

### SUMMARY OF THE INVENTION

Accordingly, the present invention has been made keeping in mind the above problems occurring in the prior art, and an object of the present invention is to decrease a computational load to the level of that of an extended Kalman filter and raise a performance level up to the level of an unscented Kalman filter by newly implementing a time propagation method performed in an existing unscented Kalman filter upon integrating multiple rate systems.

In accordance with an aspect of the present invention to accomplish the above object, there is provided a method of operating an apparatus for integrating multiple rate systems, including calculating navigation information through an inertial measurement unit, and setting mean values and variances of initial state variables of the navigation information, calculating sigma points using the mean values and the variances, time-propagating the mean values until measurement information is input through a Global Positioning System (GPS), when the measurement information is input, time-propagating the sigma points at intervals of a frequency of the measurement information, calculating variances using the time-propagated sigma points, and updating the navigation information using the time-propagated mean values, the calculated variances, and the measurement information.

Preferably, the navigation information and the measurement information may be measured at frequencies for different periods.

Preferably, the navigation information may include velocity information and attitude information calculated using a 3 or more-axis gyroscope and a 3 or more-axis accelerometer.

Preferably, the measurement information may include GPS data collected using the GPS.

Preferably, time-propagating the mean values until the measurement information is input through the GPS may be configured to time-propagate a mean value of a single initial state variable.

In accordance with another aspect of the present invention to accomplish the above object, there is provided an apparatus for integrating multiple rate systems, including a state variable information setting unit configured to calculate navigation information using an Inertial Measurement Unit (IMU), and set mean values and variances of initial state variables of the navigation information, a sigma point calculation unit configured to calculate sigma points using the mean values and the variances, a time propagation unit configured to time-propagate the mean values until measurement information is input through a Global Positioning System (GPS), and when the measurement information is input, time-propagate the sigma points at intervals of a frequency of the measurement information, an update processing unit configured to output updated navigation information in consideration of the measurement information, wherein the state variable information setting unit calculates variances using the time-propagated sigma points, and wherein the update processing unit updates the navigation information using the time-propagated mean values, the calculated variances, and the measurement information.

Preferably, the navigation information and the measurement information may be measured at frequencies for different periods.

Preferably, the IMU may include a 3 or more-axis gyroscope and a 3 or more-axis accelerometer, and collect navigation information including velocity information and attitude information using the 3 or more-axis gyroscope and the 3 or more-axis accelerometer.

Preferably, the GPS may collect the measurement information including GPS data.

Preferably, the time propagation unit may time-propagate a mean value of a single initial state variable when time-propagating the mean values.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a navigation system in which an IMU, a GPS, and an apparatus for integrating multiple rate systems are coupled according to an embodiment of the present invention;

FIG. 2 is a flowchart showing filter processing performed by a method of operating an apparatus for integrating multiple rate systems according to an embodiment of the present invention;

FIG. 3 is a flowchart showing filter processing performed by a method of operating an apparatus for integrating multiple rate systems according to another embodiment of the present invention;

FIG. 4 is a diagram showing the detailed configuration of the apparatus for integrating multiple rate systems according to an embodiment of the present invention;

FIG. 5 is a diagram showing the results of simulating the apparatus for integrating multiple rate systems according to an embodiment of the present invention;

FIG. 6 is a diagram showing the results of simulating the apparatus for integrating multiple rate systems according to an embodiment of the present invention;

FIG. 7 is a diagram showing the results of simulating the apparatus for integrating multiple rate systems according to an embodiment of the present invention; and

FIG. 8 is a diagram showing the results of simulating the apparatus for integrating multiple rate systems according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, preferred embodiments of the present invention will be described in detail with reference to the attached drawings.

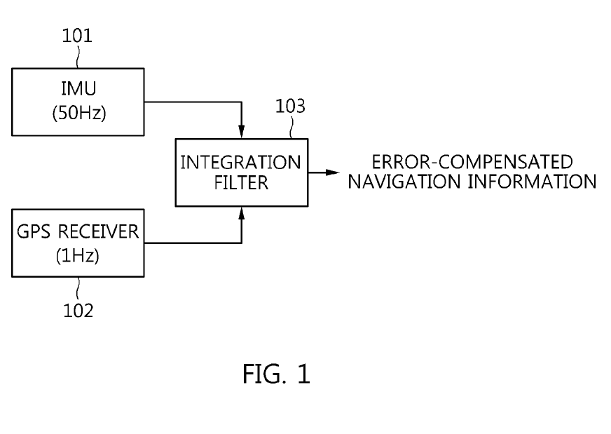

FIG. 1 is a diagram showing a navigation system in which an Inertial Measurement Unit (IMU), a Global Positioning System (GPS), and an apparatus for integrating multiple rate systems are coupled according to an embodiment of the present invention.

Referring to FIG. 1, the navigation system according to the embodiment of the present invention includes an IMU 101, a GPS receiver (or GPS) 102, and an apparatus 103 for integrating multiple rate systems (hereinafter referred to as a ‘multiple rate system integration apparatus 103’).

That is, FIG. 1 shows an embodiment in which the IMU 101 and the GPS receiver 102 are used as multiple rate systems for providing navigation information and measurement information to the multiple rate system integration apparatus 103.

Here, it is assumed that the data output period of the IMU 101 is 50 Hz (variable according to IMU), and the data output period of the GPS receiver is 1 Hz (variable according to GPS).

The two multiple rate systems are integrated with each other using the multiple rate system integration apparatus 103, and then error-compensated navigation information (position, velocity, and attitude) can be output.

A sensor error of the IMU 101 estimated by the multiple rate system integration apparatus 103 is used by the multiple rate system integration apparatus 103 to process sensor data, and the estimated value is updated whenever the multiple rate system integration apparatus 103 updates measurement values of navigation information in accordance with the output period of the GPS receiver 102.

The IMU 101 is implemented based on the use of a 3-axis gyroscope and a 3-axis accelerometer, and may also be implemented using a 3 or more-axis gyroscope and a 3 or more-axis accelerometer for Fault Detection & Isolation (FDI).

In this case, the output values of the gyroscope and the accelerometer are input to the multiple rate system integration apparatus 103 at output periods of 50 Hz.

The GPS receiver 102 estimates navigation data, such as the position and velocity of the GPS receiver 102, using signals transmitted from a GPS satellite, and inputs the estimated navigation data to the multiple rate system integration apparatus 103 at output periods of 1 Hz.

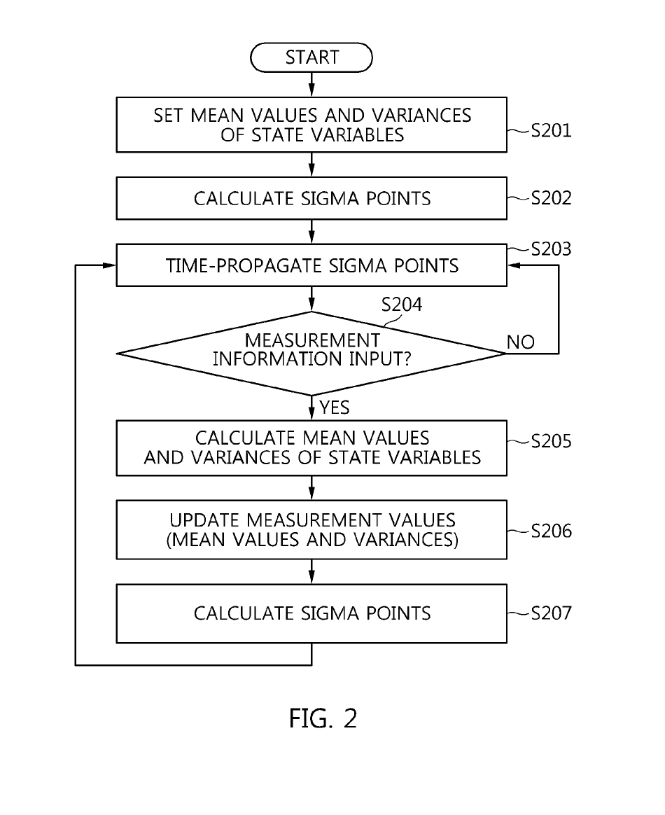

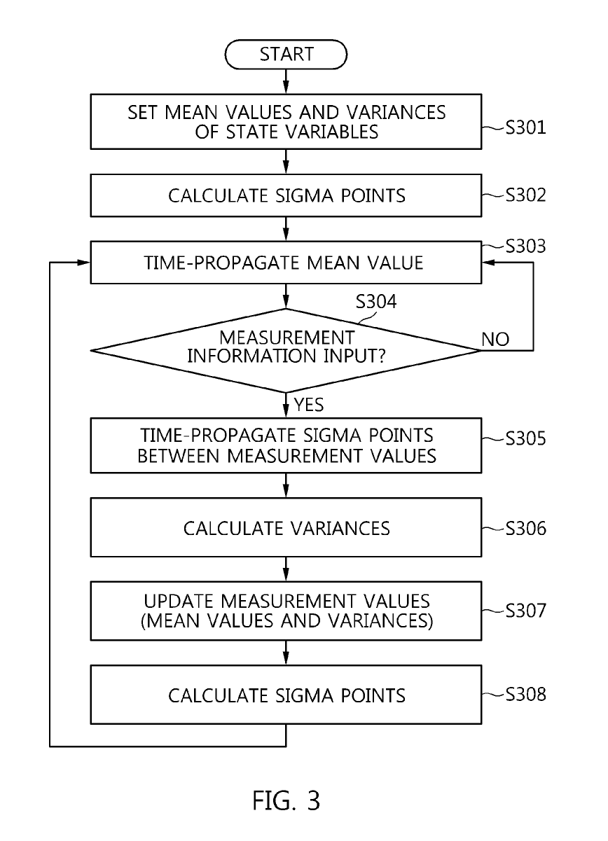

A process for outputting error-compensated navigation information using the multiple rate system integration apparatus 103 will be described in detail below with reference to FIGS. 2 and 3.

FIG. 2 is a flowchart showing filter processing performed by a method of operating the apparatus for integrating multiple rate systems according to an embodiment of the present invention.

Referring to FIG. 2, the multiple rate system integration apparatus sets the mean values and variances of initial state variables of navigation information collected by the IMU at step S201.

Thereafter, sigma points are calculated using the mean values and variances of the initial state variables at step S202.

In this case, the number of sigma points is set to 2 L+1 or L+2 according to the type of Unscented Kalman Filter (UKF) when the number of initial state variables is L, and the mean values and variances of the set sigma points are identical to the mean values and variances of the initial state variables, respectively.

Therefore, the sigma points are time-propagated, as given by the following Equation (1), in synchronization with the data output period of the IMU at step S203.

χₖ₊₁(i)=f(χₖ(i), fₖ^{b}, ωₖ^{b}, dt), i ∈ {1, 2, . . . , N} (1)

where χₖ denotes sigma points at time k and the number of sigma points is N. Further, f( ) denotes a function for time propagation, and corresponds to a formula for updating attitude, velocity, and position using IMU data (fₖ^{b} denotes the output of the accelerometer and ωₖ^{b} denotes the output of the gyroscope) in the IMU/GPS integration apparatus exemplified in the present invention. Further, dt denotes the period of time propagation, and is 1/50=0.02 when a 50 Hz IMU is used.

Here, unless GPS data that is measurement information is input, the time propagation of sigma points is continuously performed, and is performed 50 times within one second when the period of 1 Hz of the GPS data and the period of 50 Hz of IMU data are taken into consideration at step 204.

Thereafter, when GPS data is input, the mean values and variances of time-propagated state variables are calculated at step S205.

Next, the measurement values are updated using the input GPS data, and then the mean values and the variances of the state variables are recalculated at step S206.

In this case, the calculated mean values and variances of the state variables are values from which errors have been partly compensated for by using GPS measurement information.

Thereafter, sigma points are recalculated using the updated mean values and variances of the state variables at step S207, and a procedure from step S203 to step S207 may be repeatedly performed.

As described above with reference to FIG. 2, in a process for integrating the IMU and the GPS having different multiple rates with each other, time propagation is performed in accordance with the output data of the IMU having a higher rate.

In this case, 2 L+1 or L+2 sigma points are individually time-propagated, and so a computational load is inevitably increased. In order to overcome this disadvantage, a new process shown in FIG. 3 can be utilized.

FIG. 3 is a flowchart showing filter processing performed by a method of operating the apparatus for integrating multiple rate systems according to another embodiment of the present invention.

Referring to FIG. 3, the multiple rate system integration apparatus sets the mean values and variances of initial state variables of navigation information collected by the IMU at step S301.

Thereafter, sigma points are calculated using the mean values and variances of the initial state variables at step S302.

In this case, the number of sigma points may be set to 2 L+1 or L+2 according to the type of UKF when the number of initial state variables is L, and the mean values and variances of the set sigma points are identical to the mean values and variances of the initial state variables, respectively.

Thereafter, the mean value of a state variable is time-propagated at step S303.

That is, unlike in the process of FIG. 2 in which time propagation is repeated by a number of times identical to the number of sigma points, that is, 2 L+1 or L+2, in the process of FIG. 3, the mean value of only a single state variable is time-propagated.

Thereafter, step S303 is repeated until measurement information is input from the GPS. When the measured information is input at step S304, the time propagation of sigma points is performed at intervals of the frequency of the measurement information at step S305, as given by the following Equation (2):

χₖ₊₅₀(i)=f(χₖ(i), f̅ₖ^{b}, ω̅ₖ^{b}, dt×50), i ∈ {1, 2, . . . , N} (2)

In this case, since the IMU has a period of 50 Hz and the time propagation of sigma points is performed at a time between measurement values, a value of 50 is used.

Further, the output values of the accelerometer and the gyroscope denote the mean values of the accelerometer and the gyroscope obtained between the input operations of measurement information, as given by the following Equation (3):

$$\begin{matrix}{\overline{f}}_{k}^{b} = \frac{1}{50} {\sum }_{i = 1}^{50} {f}_{k + i}^{b} , & {\overline{ω}}_{k}^{b} = \frac{1}{50} {\sum }_{i = 1}^{50} {ω}_{k + i}^{b}\end{matrix} \qquad ( 3 )$$

Thereafter, variances are calculated using sigma points which have been time-propagated at a time between the measurement values at step S306.

In this case, a method of calculating the variances may be implemented using the same method as that of step S205 of FIG. 2.

Thereafter, the navigation information is updated using the mean value of the state variable time-propagated at step S303, the variances of the state variable calculated at step S306, and the obtained measurement information at step S307.

In this case, the mean values and variances are calculated using the updated navigation information, and this calculation method may be implemented using the same method as that of step S206 of FIG. 2.

Thereafter, sigma points are recalculated using the mean value and variance of the time-propagated state variable at step S308, and step S308 may be continuously repeated at step S303.

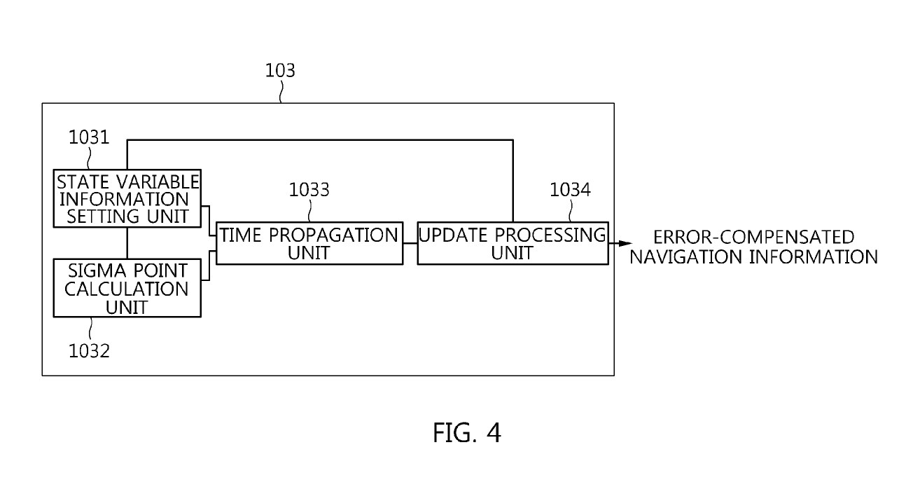

FIG. 4 is a diagram showing the detailed configuration of the multiple rate system integration apparatus according to an embodiment of the present invention.

Referring to FIG. 4, the multiple rate system integration apparatus according to the embodiment of the present invention includes a state variable information setting unit 1031, a sigma point calculation unit 1032, a time propagation unit 1033, and an update processing unit 1034.

The state variable information setting unit 1031 may calculate navigation information using an Inertial Measurement Unit (IMU), and set the mean values and variances of initial state variables of the navigation information.

The sigma point calculation unit 1032 may calculate sigma points using the mean values and variances set by the state variable information setting unit 1031.

In this case, the state variable information setting unit 1031 may calculate variances using time-propagated sigma points.

The time propagation unit 1033 time-propagates the mean values until measurement information is input from a GPS, and may time-propagate the sigma points at intervals of the frequency of the measurement information if the measurement information is input.

The update processing unit 1034 may output updated navigation information in consideration of the measurement information.

Here, the update processing unit 1034 may update the navigation information using the time-propagated mean values, the calculated variances, and the measurement information.

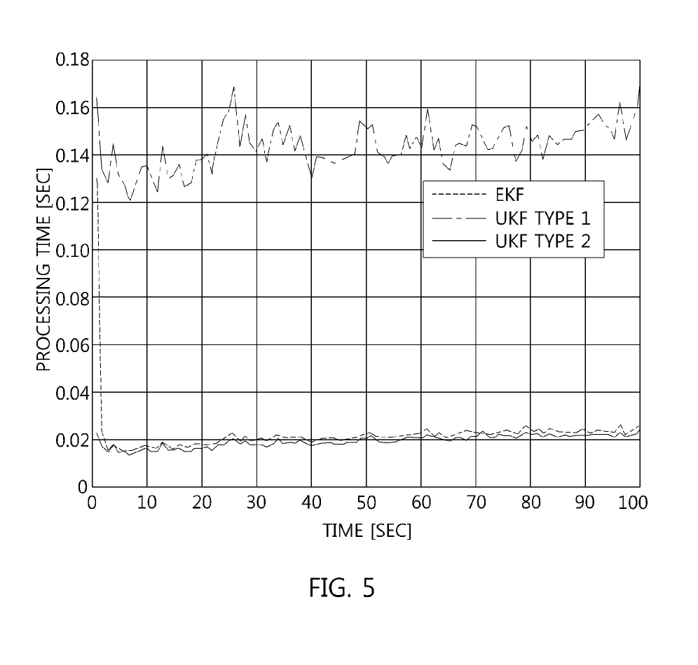

FIG. 5 is a diagram showing the results of simulating the apparatus for integrating multiple rate systems according to an embodiment of the present invention.

Referring to FIG. 5, a graph displayed in a broken line shows the results of simulation using an Extended Kalman Filter (EKF), a graph displayed in an alternate long and short dash line shows the results of simulation using a first type of UKF which performs the process of FIG. 2, and a graph displayed in a solid line shows the results of simulation using a second type of UKF which performs the process of FIG. 3.

In this case, the results of simulation show calculation times required per second in order to derive simulation results of the IMU/GPS integration system for 100 seconds, and are calculated using tic/toc commands in a Matrix Laboratory (Matlab) program.

Based on these results, it can be seen that the first type of UKF performing the process of FIG. 2 has a computational load that is about seven times as large as that of the second type of UKF performing the process of FIG. 3, and that the second type of UKF performing the process of FIG. 3 has a computational load less than that of the Extended Kalman Filter (EKF).

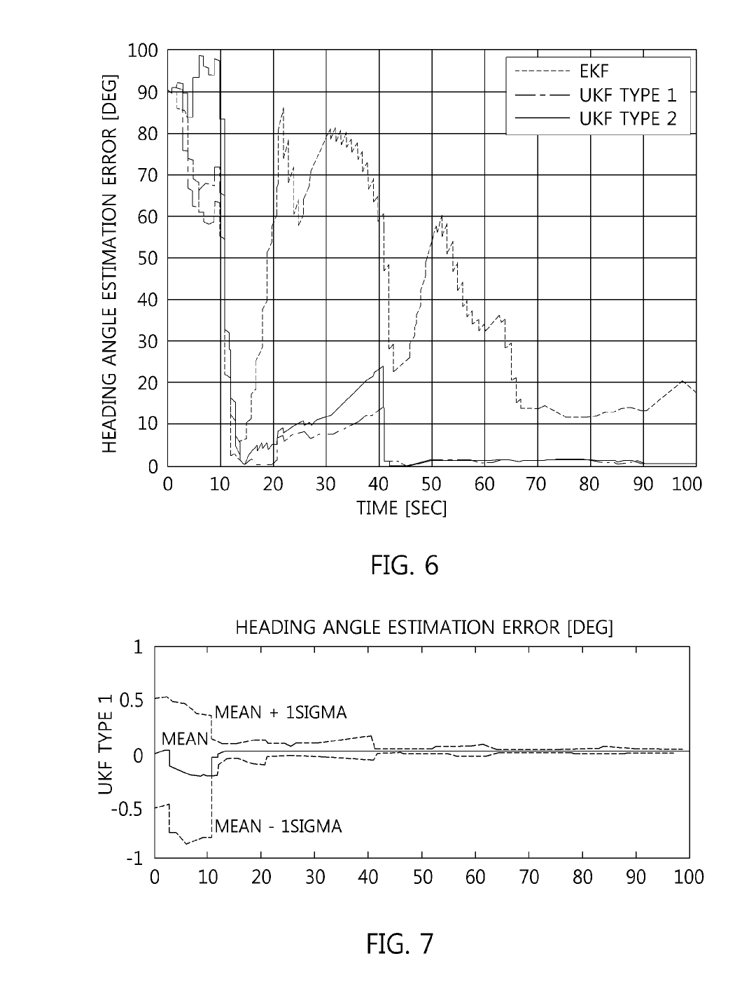

FIG. 6 is a diagram showing the results of simulating the apparatus for integrating multiple rate systems according to an embodiment of the present invention.

Referring to FIG. 6, similarly to FIG. 5, a graph displayed in a broken line shows the results of simulation using an EKF, a graph displayed in an alternate long and short dash line shows the results of simulation using a first type of UKF which performs the process of FIG. 2, and a graph displayed in a solid line shows the results of simulation using a second type of UKF which performs the process of FIG. 3.

In this case, as the condition of the simulation, a case where an error of an initial azimuth is 90 degrees is assumed. Based on this assumption, the results of simulation for estimated azimuth errors are depicted for the EKF, the first type of UKF performing the process of FIG. 2, and the second type of UKF performing the process of FIG. 3.

In the case of EKF, it can be seen that the convergence of errors is very slow, and the convergence of errors may be impossible.

In contrast, it can be seen that the first type of UKF and the second type of UKF exhibit errors converging on a value approximate to 0.

FIG. 7 is a diagram showing the results of simulating the apparatus for integrating multiple rate systems according to an embodiment of the present invention.

Referring to FIG. 7, the results of simulation using a first type of UKF that performs the process of FIG. 2 are depicted.

In this case, the simulation results show mean values and standard deviations obtained after performing Monte Carlo simulations 100 times using the first type of UKF.

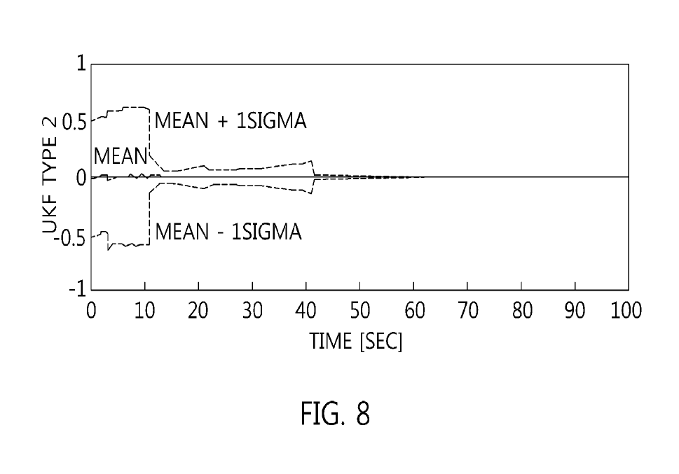

FIG. 8 is a diagram showing the results of simulating the apparatus for integrating multiple rate systems according to an embodiment of the present invention.

Referring to FIG. 8, the results of simulation using a second type of UKF that performs the process of FIG. 3 are depicted.

In this case, the simulation results show mean values and standard deviations obtained after performing Monte Carlo simulations 100 times using the second type of UKF.

When the results of the first type of UKF shown in FIG. 7 are compared with the results of the second type of UKF shown in FIG. 8, it can be seen that the second type of UKF performing the process of FIG. 3 exhibits better performance than that of the first type of UKF performing the process of FIG. 2.

Further, based on the simulation results, it can be seen that the second type of UKF performing the process of FIG. 3 is capable of not only reducing a computational load, but also improving performance.

Meanwhile, although the apparatus for integrating multiple rate systems and the method of operating the apparatus according to the embodiments of the present invention have been described as being applied to the navigation system into which the IMU and the GPS are integrated, it is also possible to apply the apparatus and method to the integration of other multiple rate systems in the same manner.

In accordance with the embodiments of the present invention, a large computational load that occurs when an existing UKF is used to integrate multiple rate systems can be reduced.

Further, in accordance with the embodiments of the present invention, errors can converge on a value approximate to 0, unlike an existing EKF in which the convergence of errors is very slow or may be impossible when an estimated error of initial state variables is large.

Furthermore, in accordance with the embodiments of the present invention, the performance of the present invention can be further improved compared to an existing UKF, as seen from the results of Monte Carlo simulations that are performed 100 times in consideration of random variables.

Although the configuration of the present invention has been described with reference to the preferred embodiments of the present invention, those skilled in the art will appreciate that various modifications, additions and substitutions are possible, without departing from the scope and spirit of the invention as disclosed in the accompanying claims. For example, the present invention can be implemented in various forms such as a storage medium in which a program for implementing the method of operating the apparatus for integrating multiple rate systems according to the present invention is recorded. Therefore, the above-described embodiments should be understood to be exemplary rather than restrictive in all aspects. Further, the scope of the present invention is defined by the accompanying claims rather than the detailed description of the invention. Furthermore, all changes or modifications derived from the scope and equivalents of the claims should be interpreted as being included in the scope of the present invention.

What is claimed is:

1. A method of operating an apparatus for integrating multiple rate systems, comprising:
calculating navigation information through an inertial measurement unit, and setting mean values and variances of initial state variables of the navigation information;
calculating sigma points using the mean values and the variances;
time-propagating the mean values until measurement information is input through a Global Positioning System (GPS);
when the measurement information is input, time-propagating the sigma points at intervals of a frequency of the measurement information;
calculating variances using the time-propagated sigma points; and
updating the navigation information using the time-propagated mean values, the calculated variances, and the measurement information.

2. The method of claim 1, wherein the navigation information and the measurement information are measured at frequencies for different periods.

3. The method of claim 1, wherein the navigation information includes velocity information and attitude information calculated using a 3 or more-axis gyroscope and a 3 or more-axis accelerometer.

4. The method of claim 1, wherein the measurement information includes GPS data collected using the GPS.

5. The method of claim 1, wherein time-propagating the mean values until the measurement information is input through the GPS is configured to time-propagate a mean value of a single initial state variable.

6. An apparatus for integrating multiple rate systems, comprising:
a state variable information setting unit configured to calculate navigation information using an Inertial Measurement Unit (IMU), and set mean values and variances of initial state variables of the navigation information;
a sigma point calculation unit configured to calculate sigma points using the mean values and the variances;
a time propagation unit configured to time-propagate the mean values until measurement information is input through a Global Positioning System (GPS), and when the measurement information is input, time-propagate the sigma points at intervals of a frequency of the measurement information;
an update processing unit configured to output updated navigation information in consideration of the measurement information,
wherein the state variable information setting unit calculates variances using the time-propagated sigma points, and
wherein the update processing unit updates the navigation information using the time-propagated mean values, the calculated variances, and the measurement information.

7. The apparatus of claim 6, wherein the navigation information and the measurement information are measured at frequencies for different periods.

8. The apparatus of claim 6, wherein the IMU comprises a 3 or more-axis gyroscope and a 3 or more-axis accelerometer, and collects navigation information including velocity information and attitude information using the 3 or more-axis gyroscope and the 3 or more-axis accelerometer.

9. The apparatus of claim 6, wherein the GPS collects the measurement information including GPS data.

10. The apparatus of claim 6, wherein the time propagation unit time-propagates a mean value of a single initial state variable when time-propagating the mean values.
